(19) United States
(12) Patent Application Publication
(10) Pub. No.: US 2024/0359909 A1
(43) Pub. Date: Oct. 31, 2024

(54) APPARATUS FOR TRANSPORTING AN OBJECT

(71) Applicant: Rezzi Corporation, Somerville, MA (US)

(72) Inventors: Andrew Murray, Somerville, MA (US); James Aronson, Medford, MA (US); Kenan Goodnight, Somerville, MA (US)

(73) Assignee: Rezzi Corporation, Somerville, MA (US)

(21) Appl. No.: 18/766,622

(22) Filed: Jul. 8, 2024

Related U.S. Application Data
(63) Continuation of application No. 17/060,556, filed on Oct. 1, 2020.
(60) Provisional application No. 62/908,908, filed on Oct. 1, 2019.

(51) Int. Cl. B65F 1/14; B25J 9/16

(52) U.S. Cl. CPC B65F 1/1468; B25J 9/1664; B25J 9/1679; B65F 1/1452; B65F 2210/128

(57) ABSTRACT

An apparatus is configured to transport an object between a first location and a second location. An attachment mechanism attaches the apparatus to the object and a battery powers the apparatus. The apparatus includes one or more sensors which measure characteristics of the external environment and at least one wheel configured to mechanically drive the apparatus. A processor determines a path between the first location and the second location and control the at least one wheel to drive the apparatus along the path.

### CROSS REFERENCE TO RELATED APPLICATIONS

This application is continuation of U.S. patent application Ser. No. 17/060,556, filed Oct. 1, 2020, and titled “APPARATUS FOR TRANSPORTING AN OBJECT,” which claims priority to and the benefit of U.S. Provisional Patent Application No. 62/908,908, filed on Oct. 1, 2019, and titled “AUTOMATED TRASH RECEPTACLE”, the contents of all of which are incorporated herein by reference as though fully set forth herein.

### FIELD OF THE TECHNOLOGY

The subject disclosure relates to devices and methods for automatically transporting an object from one location to another.

### BACKGROUND OF TECHNOLOGY

In many instances, waste/trash disposal requires an individual to move one or more trash cans between a storage location and a trash pickup location, often on a weekly basis. For some, this is just another unneeded chore added to an already overfilled schedule. For others, the inconvenience is multiplied by the number of households they are responsible for and their proximity to those households. Many are at risk of incurring a hefty fine for either bringing their trash out too early or returning it too late. The elderly and those with limited mobility are a population who may struggle to or simply may not be capable of safely moving the trash cans themselves. This population is rapidly growing with America's aging population.

Previous attempts to overcome these difficulties have included the development of full scale trash can robots that avoid obstacles and scan environments or manual trash valet services. However, these robots act as a replacement for a user's trash cans, and are not designed to work with a user's current trash cans. In some cases, a user may be responsible for a large number of trash cans, and replacing one or more trash cans with a full scale trash can robots can be prohibitively expensive. The manual valet services are only offered in limited geographies and tend to be more expensive. Thus, there is a need for a simple and affordable solution to effectively move a trash can as needed for trash pickup services.

Further, there are many other circumstances that necessitate a user manually moving an object between multiple locations. For example, doing yardwork, such as weeding a garden, may require a user to repeatedly fill a wheel barrel and deliver the wheel barrel to a disposal location where pulled weeds can be discarded. In another example, shopping carts are often returned to a carousel after use, but must then be manually returned, by a worker, to a pickup location where shoppers can retrieve them. Other applications exist in waste management and other material handling industries. Therefore there is a need for a device that can automatically transport an object between two or more locations in many industries.

### SUMMARY OF THE TECHNOLOGY

In light of the needs described above, the subject technology provides an apparatus which is configured to connect to an object to direct the object between two separate locations.

Therefore, in at least one aspect, the subject technology relates to an apparatus configured to transport an object between a first location and a second location. An attachment mechanism is configured to attach the apparatus to the object. A battery is configured to power the apparatus. At least one sensor is configured to measure characteristics of an external environment to the apparatus. At least one wheel is configured to mechanically drive the apparatus. A processor is configured to determine a path between the first location and the second location and control the at least one wheel to drive the apparatus along the path.

In some embodiments, the processor is further configured to receive an input from a user of an exemplary path between the first location and the second location. The processor can then determine the path between the first location and the second location based at least in part on the exemplary path. In some embodiments, the processor is configured to receive inputs from a user relating to a time of day and a time interval and transport the apparatus along the path at the time of day periodically based on the time interval.

In some embodiments, the at least one wheel includes a first wheel and a second wheel. The apparatus can include a first motor configured to drive the first wheel and a second motor configured to drive the second wheel. The processor is configured to selectively control the first motor and the second motor to steer the object along the path.

In some embodiments, the at least one sensors include an IMU sensor configured to measure the orientation of the apparatus, a Hall-effect sensor configured to measured wheel odometry, and a camera package configured to detect obstacles. The processor can be configured to control the at least one wheel to drive the apparatus along the path based at least in part on the measured wheel odometry. The processor can also be configured to modify the path to avoid detected obstacles while controlling the at least one wheel to drive the apparatus. In some cases, after transporting the object to the second location, the processor can determine when the apparatus has been moved based on the IMU sensor and, after the apparatus has been moved, drive the object back to the first location.

In some embodiments, the object is a residential trash can and the attachment mechanism includes a housing forming a cavity shaped to receive a lift bar of the residential trash can, the cavity opening in a partially downward direction. The attachment mechanism can then be configured to attach to the residential trash can when the cavity is positioned over the lift bar. In some embodiments, the attachment mechanism can further include a spring loaded member connected to the housing, the attachment mechanism configured such when the lift bar is positioned within the cavity, the spring loaded member engages a bottom of the residential trash can to provide a downward spring force against the housing, holding the housing against the lift bar. In some cases, the first location is a storage area for the residential trash can and the second area is a trash pickup area. In some embodiments, the processor is further configured to receive inputs from a user relating to a time of day and a time interval. The processor can then transport the apparatus along the path from the storage area to the trash pickup area at the time of day periodically based on the time interval. Finally, the processor can then identify when the residential trash can has been emptied based on the IMU sensor, and, after the residential trash can has been emptied, transport the object back to the storage area. In some cases, the processor is configured to receive the inputs relating to the time of day and the time interval after said inputs are entered by the user using a smart phone application. In some embodiments, the apparatus is further configured to determine when the path is blocked and send an alert to the user via the smart phone application. In some cases, the at least one wheel includes a first wheel and a second wheel connected via an axle, and the housing is connected to the wheel axle via a clevis joint.

In at least one aspect, the subject technology relates to an apparatus configured to transport a residential trash can between a storage area and a trash pickup area. The apparatus includes an attachment mechanism configured to attach the apparatus to the residential trash can. A battery is configured to power the apparatus. The apparatus has a plurality of wheels, including a first wheel and a second wheel. The apparatus also has a plurality of motors, including a first motor and a second motor. The first motor is configured to drive the first wheel and the second motor is configured to drive the second wheel. A camera package is configured to generate image data. The processor is configured to receive an input time from a user. The processor can also receive an input from the user of an exemplary path between the storage area and the trash pickup area. The processor can then determine an initial path between the storage area and the trash pickup area based on the exemplary path and the generated image data. The processor can then control the motors to drive the apparatus and residential trash can along the path at the input time from the storage area to the trash pickup area. After the residential trash can has been emptied, the processor can control the motors to drive the apparatus and residential trash can back to the storage area. While driving the apparatus and residential trash can along the path, the processor can detect obstacles using the image data and modify the path to avoid any detected objects.

In some embodiments, the attachment mechanism includes a housing forming a cavity shaped to receive a lift bar of the residential trash can, the cavity opening in a partially downward direction. In some cases, the attachment mechanism includes a spring loaded member connected to the housing, the attachment mechanism configured such when the lift bar is positioned within the cavity, the spring loaded member engages a bottom of the residential trash can to provide a downward spring force against the housing, holding the housing against the lift bar. In some embodiments, the attachment mechanism includes a lower support member slidably arranged within an upper support member, the lower support member and upper support member oriented vertically. A lower clamping end can extend horizontally from the lower support member and be configured to provide an upward force on the object. The attachment mechanism can also include an upper clamping end forming an L-shape with a straight horizontal portion extending from the upper support member and a straight vertical portion extending downward from the straight horizontal portion. The upper clamping end can be configured to provide a downward force on the object.

In some embodiments, the processor includes wireless capabilities and is configured to connect to an application to receive input from, and provide output to, a user. In some cases, the apparatus is configured to determine when the path is blocked and provide an alert to the user via the application. The apparatus can also be configured to determine when the apparatus has successfully traversed the path and provide an update to the user. In some cases, the apparatus is configured to identify fiduciary markers at one of the first location or the second location and position itself based upon the fiduciary markers.

### BRIEF DESCRIPTION OF THE DRAWINGS

So that those having ordinary skill in the art to which the disclosed system pertains will more readily understand how to make and use the same, reference may be had to the following drawings.

FIG. 1 is a block diagram showing operation of an apparatus in accordance with the subject technology.

FIG. 2 is an overhead view showing the operation of an apparatus in accordance with the subject technology.

FIG. 3 is a perspective view of an apparatus attached to a residential trash can in accordance with the subject technology.

FIGS. 4a-4d show a process of assembling an apparatus and connecting the apparatus to a residential trash can in accordance with the subject technology is shown.

FIG. 5 is a perspective view of an apparatus attached to a residential trash can in accordance with the subject technology.

FIG. 6 is a perspective view of an apparatus in accordance with the subject technology.

FIG. 7 is a front view of the wheels and suspension system of an apparatus in accordance with the subject technology.

### DETAILED DESCRIPTION

The subject technology overcomes many of the prior art problems, as discussed above. In brief summary, the subject technology provides a device which can attach to an object, such as a residential trash can, to move the object between multiple locations autonomously. The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e. where an “upper” part must always at a higher elevation).

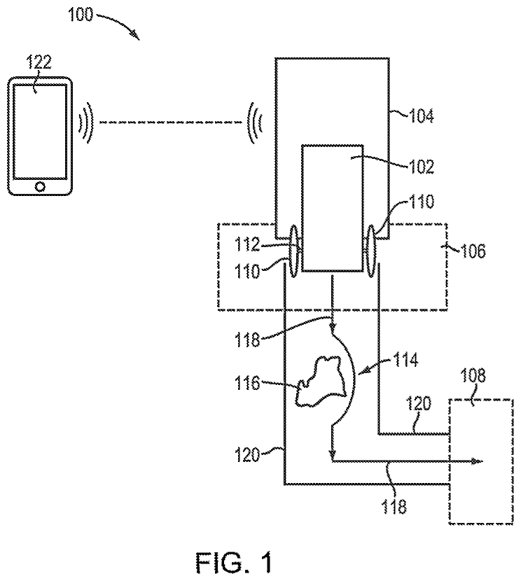

Referring now to FIG. 1, a block diagram 100 showing the operation of an apparatus 102 in accordance with the subject technology. The apparatus includes an attachment mechanism which allows it to attach to an object 104 for transporting the object 104 from a first location 106 to a second location 108. While certain particular attachment mechanisms have been found to be advantageous in certain cases, the attachment mechanism can be any device for mechanically connecting the apparatus and object, such as a latch, clasp, clamp, rivet, bolt, or the like. More complex attachment mechanisms may also be used as are discussed in more detail below. The apparatus is powered by a battery and includes a number of components which allow it to drive the attached object 104 between the two locations 106, 108. To that end, the apparatus 102 includes two wheels 110 connected via an axle 112 which are driven by one or more motors. Note that in other cases, the two wheels 110 need not be connected by an axle 112. The apparatus 102 also includes a number of sensors and an on board processor for processing and storing data, as will be discussed in more detail below.

In a typical scenario where the apparatus 102 can be effectively implemented, the first location 106 can be a docking station while the second location 108 can be a specified delivery location. For example, the apparatus 102 can be implemented in conjunction with a shopping cart (the object 104) at a grocery store. In that instance, the first location 106 could then be a shopping cart carousel, while the second location 108 could be a storage area for shopping carts. The apparatus 102 is initially trained by a user on an exemplary path 114 between the two locations 106, 108. This is accomplished by the user attaching the apparatus 102 to the object 104 and manually directing the apparatus 102 and object 104 between the first location 106 and the second location 108.

As the apparatus 102 travels along the path 114, the processor analyzes feedback from the sensors to map the surrounding environment. The processor analyzes data from a camera which views the surrounding environment. Camera data is used to determine which direction the apparatus 102 is facing, and to distinguish possible obstacles 116, such as cars or people. The camera data can also be used to map contours of the path 114 by identifying features such as a road, driveway, walkway, doorway, or the like, that the apparatus 102 will travel on or through to get from the first location 106 to the second location 108. Feedback from additional sensors is also relied upon to help map the path between the locations 106, 108. The sensors can include wheel encoders and/or Hall sensors that count the rotation of each wheel 110, an IMU sensor, and a potentiometer, for example. Based on measurements from the sensors, the processor can learn additional information about the apparatus' 102 journey along the pathway 114, including the wheel rotations required to traverse various legs of the path 114 and the degree of steering required at various points. The processor includes a navigation stack which processes this information and memorizes the path 114, using this as a basis for transporting the object 104 between the first location 106 and the second location 108 in the future.

After being trained on the path 114, the sensor data (including the camera data) can be relied on to make modifications to the actual path 118 traveled by the apparatus 102. To that end, the camera data is processed in real time to detect potential obstacles 116 along the initially mapped path 114. The processor will then modify the initial path 114, plotting a modified path 118 which avoids the obstacles 116 while still staying within any outer contours 120 initially identified (e.g. the outer edges of a roadway). Data from the other sensors can be processed to ensure the apparatus 102 is implementing the correct amount of steering and movement to avoid the obstacles 116. The processor can also use the sensor data to track how closely the apparatus 102 is actually following the desired path 118, making appropriate changes to the motor/wheel drive instructions to better optimize travel between the locations 106, 108.

The apparatus 102 includes wireless capabilities which allow it to connect to a Smart phone 122 through a Smart phone application. The apparatus 102 can connect to the Smart phone 122 using a shared wireless network or can be paired directly with a user's Smart phone 122 (e.g. using Bluetooth, cellular, or the like). Through the Smart phone application, the apparatus 102 can accept input from, or provide feedback to, the user. For example, in some instances, the apparatus 102 can be directed, via input through the application, to transport the object 104 between the locations 106, 108 at a particular time of day and/or in accordance with a given time period (e.g. weekly). The apparatus 102 can also provide alerts, or other output, to the user through the application indicating when the object 104 has successfully been delivered to a location 106, 108, or when the apparatus 102 has failed to deliver the object 104. Additionally, or alternatively, the apparatus 102 may be paired with a wireless charging station positioned at a docking location, such as within a garage, which acts as a beacon for guiding the apparatus to the docking location.

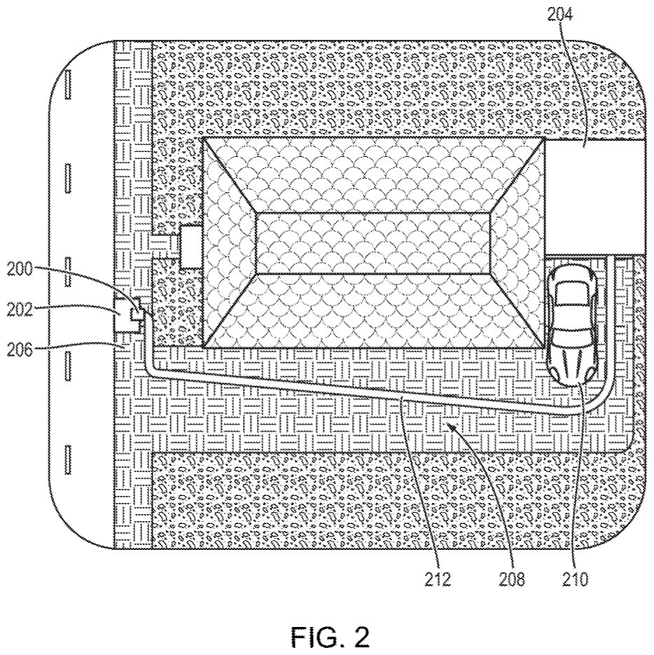

Referring now to FIG. 2, an overhead view of an environment showing the operation of an apparatus 200 in accordance with the subject technology is shown. The apparatus 200 can be configured similarly to the apparatus 102 except as otherwise shown and described. In particular, FIG. 2 shows an apparatus 200 attached to a residential trash can 202. The apparatus 200 is designed to transport the trash can 202 from a storage area (i.e. in a garage 204) to a curb 206 for trash pickup, and then return the trash can 202 to the garage 204 after trash pickup has been completed.

Therefore, a user initially teaches the apparatus 200 an exemplary path along the driveway 208 by bringing the apparatus (and connected object) between the garage 204 and curb pickup location 206. During this initial run, the cameras and other sensors will map out outer contours of the driveway 208. If, in the future, the apparatus 200 finds objects blocking the initial path taken, the apparatus 200 can develop a new modified path while staying in the contours of the driveway 208. Using a Smart phone application, the user can then input a time of day for the apparatus 200 to deliver the trash can 202 to the curb 206. Further, since trash pickup normally occurs on a given day of the week, the user can enter the trash pickup day to ensure the apparatus 200 only transports the trash can 202 to the curb 206 on that day. On the trash pickup day, and at the time entered by the user, the apparatus 200 will then deliver the trash can 202 to the curb 206 for trash pickup. Image data from the cameras will detect the car 210 in the driveway 208 (along with any other obstacles) and modify the initially trained path to plot a path 212 to the curb 206 that avoids the car 210.

In addition to the cameras, the apparatus 200 includes a number of sensors which measure various characteristics about the apparatus 200 and surrounding environment. The apparatus 200 can include IR and ultrasonic sensors to image and generate range data about the surrounding environment, in conjunction with the cameras. IMU sensors and/or potentiometers are also used to measure information about the movement and orientation of the apparatus 200 and/or object 202, allowing the processor to determine when and how the apparatus 200 is moved. Hall-effect sensors or encoders can be integrated with the wheels or axle of the apparatus 200 to track wheel odometry, including wheel angle or total number of wheel rotations. The processor can use this information from the sensors to determine how to best traverse various parts of the path between the garage 204 and curb 206, and to optimize the chosen path 212 between those locations 204, 206. Further, the apparatus 200 can use information from the sensors, in particular the IR/ultrasonic sensors and camera, to determine how to properly position itself at the curb 206 for trash pickup. Fiduciary markers can also be placed near a desired location on the curb 206, the apparatus identifying the fiduciary markers to help guide it to the proper location.

After trash pickup, the apparatus 200 will then conduct the trash can 202 back to the garage 204 for storage until the subsequent trash pickup day. The apparatus 200 can use fiduciary markers, as well as IR/ultrasonic sensors and camera data to determine how to appropriately position and dock itself within the garage 204. Further, based on the data measured by the sensors (e.g. measurements from the IMU sensors), the processor will determine when the trash can 202 has been emptied through sensor measurements indicating that the apparatus 200 has been raised and lowered. The apparatus 200 can therefore remain at the curb 206 until the trash can 202 has been emptied, before guiding the trash can 202 back to the garage 204. The apparatus 200 can also be configured to provide updates and alerts to the user on the status of the operation, including whether the trash can 202 has been successfully delivered to and from the curb 206, or whether the apparatus 200 has been unsuccessful, for example, because obstacles have blocked the apparatus 200.

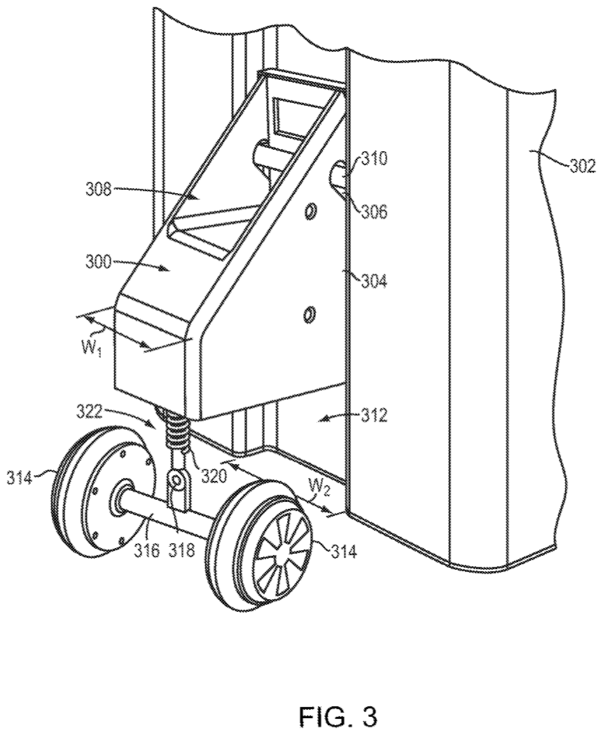

Referring now to FIG. 3, an exemplary apparatus 300 connected to a residential trash can 302 in accordance with the subject technology is shown. The apparatus 300 includes a housing 304 that can contain the battery, processor, and a number of sensors, and any other electronic components. In an upper region 308 of the housing 304, a cutout through the housing 304 sidewall forms a cavity 306 opening in an at least partially downward direction. The cavity 306 is shaped to fit around a lift bar 310 of the trash can 302, securely connecting the apparatus 300 and trash can 302. The housing 304 can also be designed with a width W1 that is commensurate with a width W2 of an indent 312 in the trash can 302 surrounding the lift bar 310. This allows the housing 304 to securely fit within the indent 312 when the apparatus 300 is attached to the trash can 302. The apparatus 300 is driven by two wheels 314 which share an axle 316. The axle 316 may include a clevis joint or comparable joint 318 which is used as an attachment point between the axle 316 and a suspension system 322. The suspension system 322 connects the axle 316 to the housing 304, and includes a suspension spring 320 which absorbs shocks, and helps the apparatus 302 traverse uneven terrain. The suspension spring 320 also helps the apparatus 300 absorb the shock of pickup and dropping, such as when the trash can 302 is emptied and then dropped.

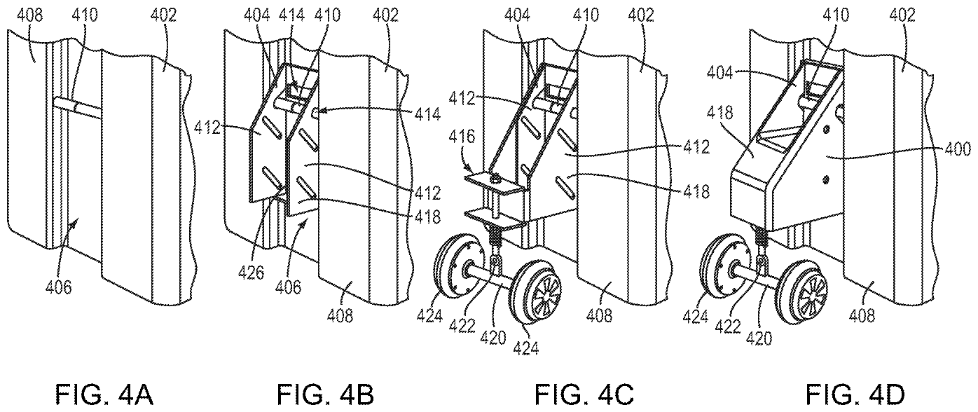

Referring now to FIGS. 4a-4d, a process of assembling the apparatus 400 and connecting the attachment mechanism 404 to a residential trash can 402 is shown. FIG. 4a shows the residential trash can 402 alone, separate from the apparatus 400. The exterior of the residential trash can 402 defines an indent 406 at the center of the rear sidewall 408 of the trash can 402. A lift bar 410 is located within the indent 406. As shown in FIG. 4b, opposing sidewalls 412 of the apparatus housing 418 can be spaced to give the apparatus 400 a width that allows it to fit comfortably within the indent 406.

The sidewalls 412 each include a cavity 414 designed to fit around the lift bar 410 to securely attach the apparatus 400 to the trash can 402. Once the housing 418 has been secured to the lift bar 410, the suspension system 416 can then be attached to the housing 418 on the side opposite the trash can 402. The suspension system 416 can then be connected to the wheel axle 420 via a clevis joint 422 allowing the wheels 424 to rotate or pivot around the joint 422 as the apparatus 400 moves. A battery 426, and other necessary components of the apparatus, can be secured within the housing 418 prior to the housing 418 being fully formed. Finally, as shown in FIG. 4d, the apparatus housing 418 can be bolted together and sealed to protect the interior components. The apparatus 400 is then ready to transport the trash can 402, as described herein.

Notably, FIGS. 4a-4d represent just one method of assembling the apparatus 400, which includes simultaneously attaching the apparatus 400 to a trash can 402. It should be understood that other methods of assembling the apparatus 400 could also be used, and one skilled in the art would understand that the apparatus 400 may be attached to the object 402 using other methods, and may be fully assembled prior to attachment to the object 402. Further, it should be understood that slight modifications to the assembly and attachment process can allow the apparatus 400 to work in conjunction with other objects (i.e. other than a residential trash can 402).

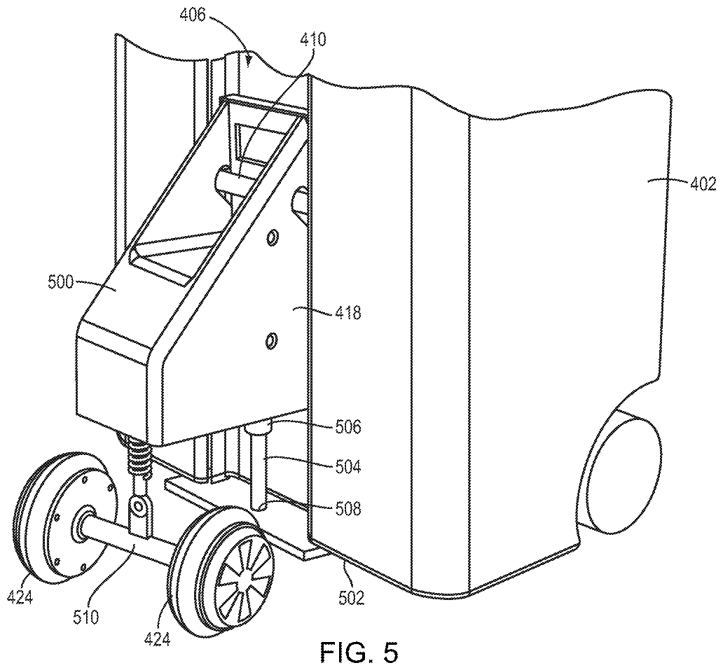

Referring now to FIG. 5, a perspective view of an apparatus 500 connected to a residential trash can 402 in accordance with the subject technology is shown. The apparatus 500 can be configured similarly to the apparatuses 300, 400 except as otherwise shown and described.

The apparatus 500 includes an attachment mechanism with an additional spring loaded member 502. After the apparatus housing 418 is positioned around the residential trash can lift bar 410, as shown in FIGS. 4a-4d, the spring loaded member 502 can engage the trash can 402 to further secure the apparatus 500 and trash can 502 together. The spring loaded member 502 is attached to the housing 418 via a spring 504, the upper end 506 of the spring 504 connecting to the underside of the housing 418 underneath the lift bar 410. The lower end 508 of the spring 500 is connected to the spring loaded member 502, which has a length that is greater than the width of the indent 406 of the trash can 402. This allows the member 502 to span across the indent 406 and anchor the housing 418 to the bottom of the trash can 402. Force from the spring 504 therefore acts between the housing 418 and the member 502, applying an upward force to pull the member 502 against the bottom of the trash can 402, and applying a downward force to pull the housing 418 securely against the lift bar 410.

The apparatus 500 also includes a large axle housing 510, which is sized to accommodate additional components of the apparatus 500. The axle housing 510 can include the entire sensor package, including any IMU sensors, Hall sensors, the camera package, and any other sensors. Further, the processor and motor controllers can be contained within the axle housing 510. Separate motors can be provided for each wheel 424, allowing the processor to drive each wheel 424 independently for steering the apparatus 500. Thus, as the processor attempts to optimize the path driven by the apparatus 500, the processor can modify the amount of turning for each wheel 424 separately.

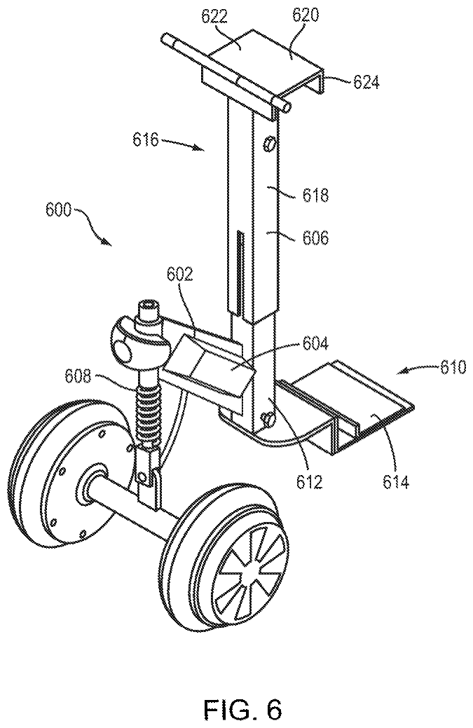

Referring now to FIG. 6, a perspective view of an apparatus 600 in accordance with the subject technology is shown. The apparatus 600 can be configured similarly to the apparatuses 300, 400, 500 except as otherwise shown and described. In particular, the apparatus 600 includes a smaller housing 602 which houses the battery 604 but is not part of the attachment mechanism 606. Instead, the housing 602 acts as a connection between the suspension system 608 and the attachment mechanism 606.

The attachment mechanism 606 includes a lower portion 610 which is includes a lower support member 612 oriented vertically upward, and a lower clamping end 614 which extends horizontally outward from the lower support member 612. The attachment mechanism 606 also includes an upper portion 616 with an upper support member 618 oriented vertically downwards. The upper support member 618 has an interior sized to accommodate the exterior of the lower support member 612, and a lower opening which allows the upper support member 618 to slide over and receive the lower support member 612. The upper clamping end 620 forms an L-shape, with a straight horizontal portion 622 leading into a vertically downward portion 624.

In some cases, a spring (not shown distinctly) within the interior of the support members 612, 618 can provide a force pulling the lower and upper clamping members 614, 620 together. Therefore, to attach the apparatus 600 to an object, the lower clamping end 614 can be positioned under a lower portion of the object, while the upper clamping end 620 can be hooked over or around a separate portion of the object. For example, in the case of a trash can, the lower clamping member 614 can be placed under the bottom lip of the trash can while the upper clamping member 620 hooks around the lift bar. The force from the spring then pulls the clamping ends 614, 620 toward one another, causing them to engage their respective contact areas of the trash can. This secures attachment of apparatus 600 to the trash can. Notably, the attachment mechanism 606 can also use other devices for applying force between the clamping ends 614, 620 as are known in the art. For example, in some cases, the spring force may be replaced by a ratcheting mechanism or lever lock. Additionally, a locking device can also be included as part of the attachment mechanism 606. Once locked, the lock can prevent the apparatus 600 from being removed from the object it has attached to. This prevents any unauthorized removal, or even theft, of the apparatus 600.

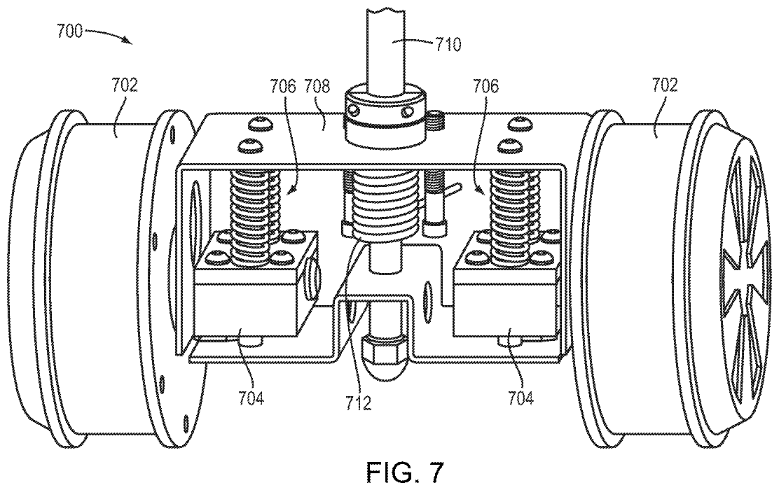

Referring now to FIG. 7, a front view of a wheel and axle configuration for an apparatus 700 in accordance with the subject technology is shown. In the arrangement of FIG. 7, the wheels 702 do not share an axle, and are each connected to their own dedicated motor 704. Further, each wheel has a separate suspension system 706 connecting it to a shared frame 708. The frame 708 then connects the wheels 702 to a central support member 710 which can serve as an attachment point between the frame 708 and the rest of the apparatus 700, such as the housing and/or attachment mechanism (not distinctly shown in FIG. 7). An additional torsion spring 712 is provided between the frame 708 and the central support member 710 to dampen rotational movements. It should be understood that this suspension and wheel arrangement can be implemented in accordance with any of the embodiments described herein.

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. An apparatus configured to transport an object between a first location and a second location comprising:
an attachment mechanism configured to releasably attach the apparatus to the object;
a battery configured to power the apparatus;
at least one wheel configured to mechanically drive the apparatus;
a processor configured to determine a path between the first location and the second location and control the at least one wheel to drive the apparatus along the path;
an IMU sensor configured to measure the orientation of the apparatus;
a Hall-effect sensor configured to measure wheel odometry; and
a camera package configured to detect obstacles.

2. The apparatus of claim 1, wherein the processor is further configured to:
receive an input from a user of an exemplary path between the first location and the second location; and
determine the path between the first location and the second location based at least in part on the exemplary path.

3. The apparatus of claim 1, wherein the processor is configured to:
receive inputs from a user relating to a time of day and a time interval; and
transport the apparatus along the path at the time of day periodically based on the time interval.

4. The apparatus of claim 1, wherein the at least one wheel a first wheel and a second wheel connected via an axle;
the apparatus includes a first motor configured to drive the first wheel and a second motor configured to drive the second wheel; and
the processor is configured selectively control the first motor and the second motor to steer the apparatus.

5. The apparatus of claim 4, wherein the processor is configured to:
control the at least one wheel to drive the apparatus along the path based at least in part on the measured wheel odometry;
modify the path to avoid detected obstacles while controlling the at least one wheel to drive the apparatus; and
after transporting the object to the second location, determine when the apparatus has been moved based on the IMU sensor and, after the apparatus has been moved, transport the object back to the first location.

6. The apparatus of claim 1, wherein:
the object is a residential trash can and the attachment mechanism includes a housing forming a cavity shaped to receive a lift bar of the residential trash can, the cavity opening in a generally downward direction; and
the attachment mechanism is configured to attach to the residential trash can when the cavity is positioned over the lift bar.

7. The apparatus of claim 6, wherein the attachment mechanism includes a spring loaded member connected to the housing, the attachment mechanism configured such when the lift bar is positioned within the cavity, the spring loaded member engages a bottom of the residential trash can to provides a downward spring force against the housing, holding the housing against the lift bar.

8. The apparatus of claim 6, wherein the first location is a storage area for the residential trash can and the second area is a trash pickup area.

9. The apparatus of claim 6, wherein the processor is configured to:
receive inputs from a user relating to a time of day and a time interval;
transport the apparatus along the path from the storage area to the trash pickup area at the time of day periodically based on the time interval; and
identify when the residential trash can has been emptied based on the IMU sensor, and, after the residential trash can has been emptied, transport the object back to the storage area.

10. The apparatus of claim 9, wherein:
the at least one wheel a first wheel and a second wheel connected via an axle; and
the housing is connected to the wheel axle via a clevis joint.

11. An apparatus configured to transport an object between a first area and a second area, the apparatus comprising:
an attachment mechanism configured to releasably attach the apparatus to the object;
a battery configured to power the apparatus;
a plurality of wheels including at least one wheel configured to mechanically drive the apparatus and residential trash can;
a motor configured to drive the at least one wheel;
a camera package configured to detect obstacles; and
a processor configured to:
receive an input time from a user;
receive an input from the user of an exemplary path between the first area and the second area;
determine a path between the first area and the second area based on the exemplary path and any detected obstacles; and
control the motor to drive the apparatus and object along the path at the input time.

12. The apparatus of claim 11, wherein the object is a trash can, the first area is storage area and the second area is trash pickup location.

13. The apparatus of claim 12, wherein the object is a residential trash can.

14. The apparatus of claim 13, further comprising:
an IMU sensor configured to measure the orientation of the apparatus; and
a Hall-effect sensor configured to measure wheel odometry.

15. The apparatus of claim 1, further comprising:
an IMU sensor configured to measure the orientation of the apparatus; and
a Hall-effect sensor configured to measure wheel odometry.
